(19) United States
(12) Patent Application Publication
(10) Pub. No.: US 2013/0187792 A1
(43) Pub. Date: Jul. 25, 2013

(54) EARLY WARNING SYSTEM FOR TRAFFIC SIGNALS AND CONDITIONS

(71) Applicant: Mark Egly, Des Moines, IA (US)

(72) Inventor: Mark Egly, Des Moines, IA (US)

(21) Appl. No.: 13/414,814

(22) Filed: Mar. 8, 2012

Related U.S. Application Data
(60) Provisional application No. 61/588,485, filed on Jan. 19, 2012.

(51) Int. Cl. G08G 1/0965; B60Q 1/00

(52) U.S. Cl. 340/901; 340/439

(57) ABSTRACT

An early warning system having a plurality of vehicles, a plurality of smart phones, a plurality of signals and a command center which are electronically in communication with one another. Each vehicle, smart phone and signal which is part of the system has at least one receiver, sensor, processor, controller, transmitter and software. As a first vehicle approaches a second vehicle, a signal or a pedestrian carrying a smart phone, the transmitter connected to the second vehicle, a signal or a pedestrian sends information about the second vehicle, signal or pedestrian to the first vehicle. The first vehicle's processor process that information pursuant to the software and determines whether a hazard condition exists. In the event that a hazard condition exists, a warning device alarms the driver as to the existence of the hazard thereby helping the driver to avoid an accident and preventing property and personal injury.

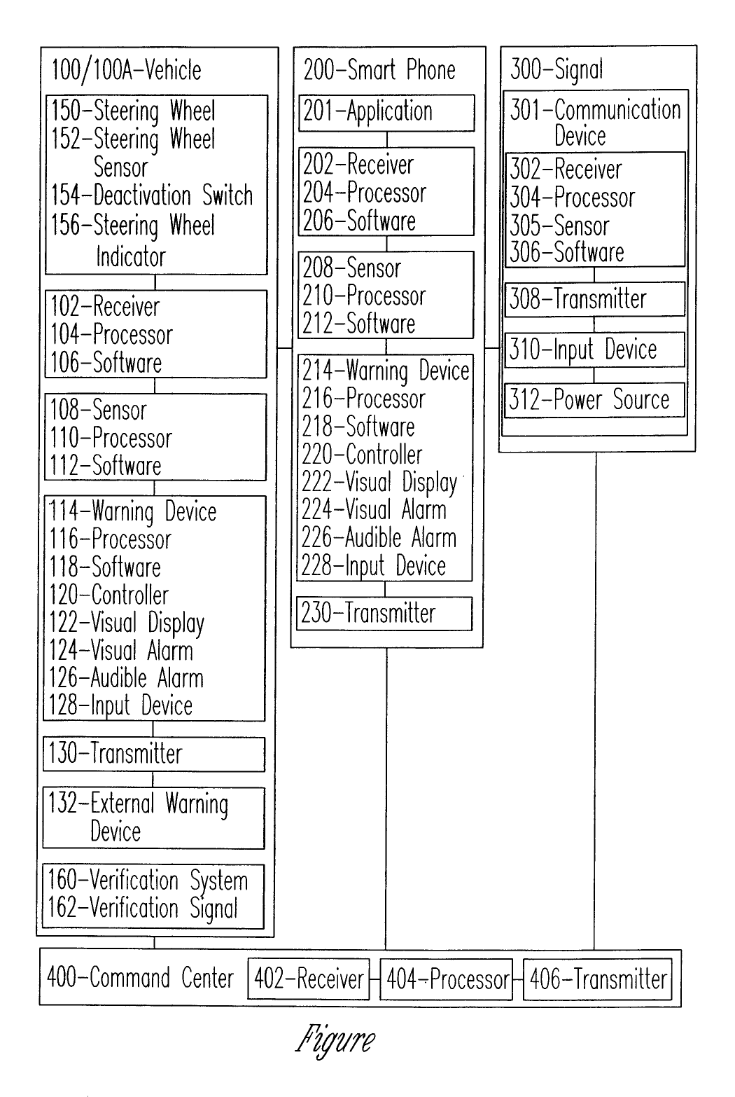

### CROSS REFERENCE TO RELATED APPLICATION

This application claims the benefit of U.S. Provisional Application Ser. No. 61/588,485 filed Jan. 19, 2012.

### BACKGROUND OF THE INVENTION

This invention is directed towards an early warning system. More specifically and without limitation, this invention is directed towards an early warning system for traffic signals and driving conditions.

Warning systems for drivers are well known in the art. Warning systems include signs, flashing lights, stop lights, sirens, and horns, to name a few, which are all designed to inform drivers of conditions and prevent collisions, property damage and injury. Despite this complex array of warning systems, one of today's leading causes of death and injury are automobile accidents.

New technology has been brought into the vehicle, such as cellular telephones with various apps and texting, GPS devices, satellite radios, and other visual displays. While in some ways these devices improve the safety of driving by providing drivers with additional information, these devices also add additional distractions to drivers which has been an important factor in an increasing number of accidents.

Therefore, despite the advances in technology, problems still remain. Namely, new technology has increased distractions that a driver must see past in order to drive safely.

Thus a primary object of the present invention is to provide an early warning system to alert drivers to dangerous conditions.

Another object of the present invention is to improve the safety of driving.

Yet another object of the present invention is to reduce the number of injuries and fatalities due to automobile accidents.

Another object of the present invention is to reduce the amount of property damage caused by automobile accidents.

These and other objects, features, or advantages of the present invention will become apparent from the specification and claims.

### SUMMARY OF THE INVENTION

An early warning system having a plurality of vehicles, a plurality of smart phones, a plurality of signals and a command center which are electronically in communication with one another. Each vehicle, smart phone and signal which is part of the system has at least one receiver, sensor, processor, controller, transmitter and software. As a first vehicle approaches a second vehicle, a signal or a pedestrian carrying a smart phone, the transmitter connected to the second vehicle, a signal or a pedestrian sends information about the second vehicle, signal or pedestrian to the first vehicle. The first vehicle's processor process that information pursuant to the software and determines whether a hazard condition exists. In the event that a hazard condition exists, a warning device alarms the driver as to the existence of the hazard thereby helping the driver to avoid an accident and preventing property and personal injury.

### BRIEF DESCRIPTION OF THE DRAWINGS

The FIGURE is a schematic view of the early warning system.

### DETAILED DESCRIPTION OF THE INVENTION

With reference to the FIGURE, an early warning system 10 is presented having a plurality of vehicles 100, smart phones 200, traffic signals 300 and at least one command center 400.

Vehicle 100 has a receiver 102 which receives signals and information about driving conditions from traffic signals 300, Smart Phones 200, other vehicles 100 and command center 400. Receiver 102 has a processor 104 which processes the information received from traffic signal 300. Receiver 102 has software 106 which provides the manner and method of interpreting the information received from signal 300. Preferably, vehicle 100 has a receiver 102 connected to the front bumper, or the forward end, of the vehicle 100 and a receiver 102 connected to the back bumper, or rearward end, of the vehicle 100 so as to receive and project information forward and rearward of the vehicle 100.

Vehicle 100 also has at least one sensor 108. Sensor 108 has a processor 110 and software 112. Sensor 108 senses conditions related to the vehicle such as speed, direction, location, whether an accident has occurred, whether the driver is using a cell phone, and whether the driver is texting, among other conditions. Sensor 108 also senses conditions external to vehicle 100 such as the presence of objects (such as vehicles which are not part of system 10, curbs, bridge embankments, poles, signs, building structures, barricades, trains, buses, bicyclists, etc.). Processor 110 processes the information received from sensor 108 pursuant to the software 106 which provides the manner and method of interpreting the information received from sensor 108.

Vehicle 100 also has a warning device 114. Warning device 114 has a processor 116, software 118 and controller 120. Processor 116 processes the information received from receiver 102 and sensor 108 pursuant to the software 118 which provides the manner and method of interpreting the information received from receiver 102 and sensor 108.

Warning device 114 has a visual display unit 122, a visual alarm 124, an audible alarm 126 and an input device 128. Visual display unit 122 is any type of a visual display such as an LCD screen or the like that is positioned within the vehicle in sight and reach of the driver. Visual alarm 124 is any type of a device that visually alerts the driver to an upcoming hazardous condition such as an indicator or flashing light or a warning symbol. The visual alarm 124 is either a stand alone unit, such as a single light attached to the dashboard of the vehicle 100, or otherwise the visual alarm 124 is incorporated within the visual display unit 122, such as a warning sign that appears when a hazardous condition is approached. Input device 128 is any device which allows the user to input information and control the warning device such as a mouse, a keyboard, a dial pad, a touch screen, an arrangement of buttons, a combination of any of these devices, or the like, that allows the driver to control, operate, activate, deactivate, and silence the device.

Vehicle 100 also has a transmitter 130 which transmits information about vehicle 100, such as speed, direction, location, whether an accident has occurred, among other information. Transmitter 130 transmits this information to command center 400 as well as other vehicles 100 or smart phones 200 which are operating as part of this system 10.

Vehicle 100 also has an external warning device 132. External warning device 132 is any device which broadcasts to the outside world that a hazard condition has occurred. External warning device 132 includes a siren, horn, strobe lights, flashing lights, colored lights, or the like or any combination of these external warning systems 132 that can be used to alert persons external to the vehicle that a hazard condition has occurred. This external warning device 132 operates like warning device 114 in that the warning signal emanated from warning device 132 is changes to fit the hazard condition, i.e. as the intensity of the hazard condition increases, so does the intensity of the warning signal as is described herein. This external broadcast of the warning signal is an attempt to make other vehicles and pedestrians aware of the hazard condition. Any increase in awareness can possibly reduce accidents or damage.

Smart phone 200, as is used herein, is not to be construed as a limiting term. In contrast, the term “smart phone” is to be construed broadly to include any electronic device which has, or could, possess the capabilities expressed herein. Smart phone 200 has an application 201 which is a program or software that controls the smart phone's function. Smart phone 200 has a receiver 202 which receives signals and information about driving conditions from traffic signal 300. Receiver 202 has a processor 204 which processes the information received from traffic signal 300. Receiver 202 has software 206 which provides the manner and method of interpreting the information received from signal 300.

Smart phone 200 also has at least one sensor 208. Sensor 208 has a processor 210 and software 212. Sensor 208 senses conditions related to the phone 200 such as speed, direction and location. Processor 210 processes the information received from sensor 208 pursuant to the software 206 which provides the manner and method of interpreting the information received from sensor 208.

Smart phone 200 also has a warning device 214. Warning device 214 has a processor 216, software 218 and controller 220. Processor 216 processes the information received from receiver 202 and sensor 208 pursuant to the software 218 which provides the manner and method of interpreting the information received from receiver 202 and sensor 208.

Warning device 214 has a visual display unit 222, a visual alarm 224, an audible alarm 226 and an input device 228. Visual display unit 222 is any type of a visual display such as an LCD screen or the like. Visual alarm 224 is any type of a device that visually alerts the driver to an upcoming hazardous condition such as an indicator or flashing light or a warning symbol. The visual alarm 224 is either a stand alone unit, such as a single light attached to the smart phone 200, or otherwise the visual alarm 224 is incorporated within the visual display unit 222, such as a warning sign that appears when a hazardous condition is approached. Input device 228 is any device which allows the user to input information and control the warning device such as a mouse, a keyboard, a touch screen, an arrangement of buttons, a combination of any of these devices, or the like, that allows the driver to control, operate, activate, deactivate, and silence the device.

Smart phone 200 also has a transmitter 230 which transmits information about the smart phone 200, such as speed, direction, location, whether an accident has occurred, among other information. Transmitter 230 transmits this information to command center 400 as well as other vehicles 100 or smart phones 200 which are operating as part of this system 10.

The system 10 has a plurality of traffic signals 300. Traffic signal 300 is any traffic signal or sign known. Traffic signal 300 includes passive signals which do not change signal or activate/deactivate such as stop signs, yield signs, “Wrong Way” signs, “Do Not Enter” signs, speed limit signs, construction zone signs, cross walk signs, railroad crossing signs, divided highway signs, no turn signs, turning signs, one way signs, warning signs, hazard signs, school zone signs, deaf child signs, animal crossing signs, dead end signs, road closed signs, added lane signs, closed lane signs, one way signs, or the like. Traffic signal 300 also includes active signals which change signal or activate/deactivate such as stop lights, turning lights, walk/don't-walk signals, school zone signals, drawbridge signals, rail road crossing signals, HOV restrictions, road closures, maintenance or road construction signals, or the like.

Traffic signal 300 has a communication device 301 which has a receiver 302 which receives signals from command center 400, a processor 304 which processes the information received, a sensor 305 for sensing the condition of the signal 300, software 306 which provides the manner and method of interpreting the information received from command center 400 and sensor 305 and a transmitter 308 for transmitting information pursuant to the processor 304 and software 306. As one example, if the traffic signal 300 is a rail road crossing, sensor 305 senses whether a train is approaching or present and whether the warning system is activated. As another example, if traffic signal 300 is a stop light, sensor 305 senses the condition of the light, whether it is red, green or yellow. Transmitter 308 transmits information about the signal 300 to vehicles 100, smart phones 200 and command center 400. As an example, if signal 300 is a stop light, transmitter 308 transmits information as to whether the light is red, green or yellow, as well as the timing of when the light will change signals. As another example, if signal 300 is a school zone signal, transmitter 308 will transmit whether the school zone is active and therefore the speed limit is lower, or whether the school zone is not active and therefore the speed limit is higher.

As another example, sensor 305 can sense dangerous conditions such as rain, snow, ice, high winds, accidents, slow traffic, diminished visibility such smoke or fog, etc. The software 306 and processor 304 process this information. When a hazard condition is determined to exist, transmitter 308 transmits the presence of a hazard condition.

Traffic signal 300 also has a manual input device 310 which allows a user to activate or deactivate the traffic signal 300, and/or change or input the settings, that is when the signal 300 is active/inactive, what conditions activate the signal 300, etc. The input device 310, in the example of the signal 300 being a work zone sign, allows the road workers to manually activate the sign when they are on sight, and deactivate the signal 300 when they leave. To prevent tampering, input device 310 such as a key pad is locked behind a compartment door. Alternatively, input device 310 is connected wirelessly to signal 300 though a wireless network or the like, such as a smart phone 200 or command center 400. In this arrangement, input device 310 is locked by a password or other security device or measure.

Traffic signal 300 also has a power source 312 connected to it to provide power to the signal 300. Power source 312 includes any power source including a battery, a gas powered motor and generator, a solar panel, connection to the power grid, or the like or a combination of these power sources. Power source 312 allows signal 300 to operate in any and all conditions.

The system 10 also has a command center 400. Command center 400 has a receiver 402 which receives signals and information about driving conditions from vehicles 100, smart phones 200 and traffic signals 300. Receiver 402 has a processor 404 which processes the information received from vehicles 100, smart phones 200 and traffic signals 300. Receiver 402 has software 406 which provides the manner and method of interpreting the information received from vehicles 100, smart phones 200 and traffic signals 300.

Command center 400 also has a transmitter 408 for transmitting information to vehicles 100, smart phones 200 and traffic signals 300. Through transmitter 408, command center 400 can transmit instructions to traffic signals 300 so as to control the manner in which they operate. As an example, if the signal is a school zone and summer time arrives command center 400 can deactivate the school zone warning signal. As another example, if command center 400 receives a signal that a vehicle 100 which is part of this system is in an accident, command center 400 can transmit this information to other vehicles 100 or smart phones 200 that are in and approaching the area.

In another embodiment, traffic signals 300 do not have communication devices 301 embedded within them, instead, command center 400 directly transmits information about upcoming traffic signals 300 to vehicles 100 and smart phones 200. In this way system 10 is centralized and does not require embedding communication devices 301 in countless traffic signals 300.

In operation, as one example, as a vehicle 100 is approaching a traffic signal 300 that is turning from green to yellow, sensor 305 within communication device 301 connected to signal 300 senses the condition of the signal 300. The software 306 process this information and directs transmitter 308 to transmit that the present condition of the signal 300 is green and that in a specified amount of time that the signal 300 will change from green to yellow.

This signal is received by receiver 102 within vehicle 100 that is within receiving distance of signal 300. Simultaneously, sensor 108 within vehicle 100 senses the present condition of the vehicle 100, such as its speed, direction of travel, location and whether the driver is talking on a cell phone or texting on a cell phone. The processor 116 of warning device 114 processes the information from sensor 108 and traffic signal 300 pursuant to the instructions of software 118. In this particular example, the processor 116 will calculate whether a warning condition exists. To make this determination, processor 116 will calculate the distance between the vehicle 100 and the traffic signal 300, the speed of the vehicle, the direction of travel of the vehicle, whether the vehicle is accelerating or decelerating, whether the brakes are applied, and any other relevant condition. Pursuant to the software 118, processor 116 will make a determination as to whether a warning condition exists.

If a warning condition exists, controller 120 will activate visual alarm 124 and/or audible alarm 126 to alert the driver of the warning condition. In addition, controller will activate external warning device 132. There are many levels of warning conditions depending on the severity of the condition. Visual alarm 124 has the ability to increase in brightness, so that as the warning condition elevates, so does the brightness of the visual alarm 124. The visual alarm 124 also has the ability to change color, so that as the warning condition elevates, so does the warning level of the color. As an example, from green, for a low severity condition, to yellow and then red as the severity of the condition increases. Audible alarm 126 also has the ability to increase in volume, so that as the warning condition elevates, so does the volume of the alarm. Audible alarm 126 also has the ability to change tone and sound. As an example, when a low severity condition exists audible alarm 126 is a simple bell or “ding”. As the severity of the warning condition elevates the audible alarm 126 changes to an alarm of ever increasing severity. Similarly, the external warning device 132 is activated sounding a siren or horn while also activating warning lights, to the intensity that matches the intensity of the hazard condition.

If, in the event, sensor 108 senses that the driver is using a cell phone (such as searching for contacts, activating an app, or manipulating the cell phone in any other way), talking on a cell phone, or texting on a cell phone, processor 116 and software 118 will take this condition into consideration. This will cause the sensitivity and severity of a warning condition to increase greatly. That is, a warning condition will be determined to occur much further away from the traffic signal 300 than it would be had the driver not been using a cell phone. Also, the warning signal from visual alarm 124 and audible alarm 126 will be of a more severe nature, that is louder and brighter. In this way, the warning device 114 and system 10 alerts the driver to a potentially dangerous condition thereby helping to prevent accidents, collisions, property damage, injuries or fatalities.

As another example, in the event that visibility is diminished due to fog, rain, snow or smoke from a fire, sensor 305 on signal 300 senses that visibility is diminished. The processor 304 and software 306 determine that a hazard condition exists and transmits a hazard signal through transmitter 308. As vehicles 100 approach signal 300, the vehicle's receiver 102 receives this hazard signal, and indicates the driver of the hazard through activation of the warning device 114.

As another example, in the event that a collision occurs to a vehicle 110 which is part of the herein described early warning system 10, the sensor 108 of the vehicle will sense the location of the vehicle and that a collision has occurred. The transmitter 130 will then transmit that a hazard condition exists at that location.

As another vehicle 100 which is part of the herein described early warning system 10 approaches the area of the collision, receiver 102 receives the signal regarding the hazard condition. The processor 116 of the warning device 114 processes this information along with the speed, location and direction information provided by sensor 108 pursuant to the instructions of software 118. In the event that a warning condition occurs, visual alarm 124 and audible alarm 126 are activated as is described above. In this way, the warning device 114 and system 10 alerts the driver to a potentially dangerous condition thereby helping to prevent accidents, collisions, property damage, injuries or fatalities.

As another example, receiver 102 in vehicle 100 receives information regarding other potential, but not immediate warning conditions within the vicinity of vehicle 100. These signals are received from transmitters 308 connected to signs or signals 300. These potential warning conditions are displayed on a map of the area surrounding vehicle 100 on visual display 122. These potential warning conditions and signals include collisions, traffic jams, construction zones, road closures, reduced lanes, added lanes, HOV restrictions, school zones, speed limits, speed zones, disabled vehicles, emergency vehicles, the direction of travel of one-way streets, emergency zones, stop signs, stop lights, yield signs, turn lanes, dead ends, temporary traffic controls, rail road crossings, and any other traffic or regulatory signals. Processor 116 will continuously monitor all of the potential hazard conditions as well as the speed, direction and all other conditions of vehicle 100 to determine whether a hazard condition exists that requires activation of the visual alarm 124 and/or audible alarm.

If a warning condition exists, controller 120 will also take control of the vehicle 100. That is, in the event that a sensor 108, processor 110 and software 112 determine that a collision or other hazard will occur, controller 120 will cut the vehicle's engine power, and/or activate the vehicle's brakes, and/or take control of the vehicle's steering to avoid the hazard or collision or lessen the force of the collision. In the event that this occurs, sensor 108 will sense the conditions external to the vehicle 100 (such as the presence of other vehicles which are not part of the system 10, buildings, curbs, barricades, pedestrians, etc) and guide vehicle 100 away from these objects while slowing and stopping vehicle 100. The system 10 will also use GPS information to help guide the vehicle 100 away from hazards such as bridge embankments, light poles, buildings or other obstacles as the vehicle 100 is brought to a stop.

As another example, a pedestrian carrying a smart phone 200 or using an electronic device attached to head phones which is part of this system 10 and is running application 201 on the smart phone 200 enters a street without observing whether any vehicles 100 are approaching. The transmitter 230 of the smart phone 200 transmits the location, direction, speed and other information of the smart phone 200 to all other smart phones 200 and vehicles 100 which are part of this system 10.

In the event that a vehicle 100, which is part of this system, is approaching the pedestrian the receiver 102 of the vehicle 100 will receive the location, direction, speed and other information from smart phone 200. Simultaneously, sensor 108 within vehicle 100 senses the present condition of the vehicle 100, such as its speed, direction of travel, location and whether the driver is talking on a cell phone or texting on a cell phone. The processor 116 of warning device 114 processes the information from sensor 108 and smart phone 200 pursuant to the instructions of software 118. In this particular example, the processor 116 will calculate whether a warning condition exists. To make this determination, processor 116 will calculate the distance between the vehicle 100 and the smart phone 200, the speed of the vehicle 100, the direction of travel of the vehicle 100, whether the vehicle 100 is accelerating or decelerating, whether the brakes are applied, and any other relevant condition. Pursuant to the software 118, processor 116 will make a determination as to whether a warning condition exists, that is, whether the vehicle 100 is projected to collide or come close to the pedestrian carrying smart phone 200.

If a warning condition exists, controller 120 will activate visual alarm 124 and/or audible alarm 126 to alert the driver of the warning condition at the proper warning level as is described above.

The pedestrian carrying smart phone will similarly be alerted to a warning condition by smart phone 200. In the event that the pedestrian is using smart phone 200, such as texting or talking, the application 201 or warning device 214 will interrupt the pedestrian to alert them to the existence of a warning condition. Or, as is very popular, many people listen to music on their MP3 players (which like smart phones 200 can be part of this system by running application 201) or on their smart phones 200. Often times these people are at an increased risk for injury as their attention is captivated by the music and their senses to the external world are dulled. In the event that a hazard condition occurs, warning device 214 will interrupt the music and inform the user that a hazard condition has occurred. This may include a verbal signal such as “Warning” or “Approaching Vehicle” or “Danger” or alternatively a signal or sound such as a beep, alarm or siren. In this way, the early warning system will help to prevent collisions between vehicles 100 and pedestrians carrying smart phones 200. This is particularly helpful when hazard conditions approach the pedestrian, jogger or biker from behind, as is often the case. This warning will eliminate the need to turn around to see if a vehicle is approaching from behind, which can cause accidents or injuries in and of itself. This will also provide the user with the opportunity to escape a potential collision, or move over to the side of the road.

As another example, a signal 300 is positioned on a curve in the road. As a vehicle 100 approaches the signal 300, receiver 302 receives information about an oncoming vehicle 100, or alternatively sensor 305 senses the oncoming vehicle 100, including its speed, direction and trajectory. Sensor 305 also senses road conditions, such as whether the curve is wet, snow covered, iced over, or dry. Processor 304 processes this information pursuant to the instructions of software 306 and determines whether a hazard condition exists, i.e. the vehicle 100 is traveling too fast, or too fast for the conditions. In the event that a hazard condition exists, the warning system is activated. That is, the sign illuminates, flashes, sounds a siren or in any other way alerts the driver to the hazard condition. In addition, signal 300 transmits this warning signal through transmitter 308 to the driver's smart phone 200 or directly to vehicle 100 to activate the warning device 114, 214 therein, as is described above. In this way the signal 300 prevents the driver from driving off of the curve in the road based on the speed, direction and trajectory of the vehicle 100 and the conditions of the road.

In another arrangement, system 10 helps to prevent accidents or hazard conditions by preventing the use of cellular phones while in the vehicle 100. This is particularly helpful for parents of children who have smart phones 200 and recently received the privilege to drive. The parents enter through input device 128 in vehicle 100, or input device 228 in smart phone 200, a setting that prevents smart phone 200 from talking, texting, web browsing, e-mailing, or any other like functions, or any combination of these functions or all functions when the smart phone 200 is inside vehicle 100, and/or when vehicle 100 is moving. To accomplish this arrangement, sensor 108 of vehicle 100 and/or sensor 208 of smart phone 200 sense whether the smart phone 200 is inside vehicle 100 and/or inside vehicle 100 and vehicle 100 is moving. When this condition is sensed, the selected functionality of smart phone 200 is locked or prevented until the vehicle 100 is stopped or until the smart phone exits vehicle 100. These settings can be password protected under an administrative or parent account so that they can be set by the parent yet not changed by the child. By limiting the functionality of smart phone 200 when driving, this limits the potential distraction that the user faces which will help to prevent accidents due to inattentiveness.

While the above-described examples are described with respect to the early warning system 10 being incorporated within vehicle 100, the system 10 would operate in the same manner if a smart phone 200 running application 201 was used instead of a the system 10 being installed directly onto and into vehicle 100. That is, when the user is running the application 201 on a smart phone 200 and they step into the vehicle 100.

This technology can also be incorporated into any object which is used, carried or worn by persons, such as garments of clothing, hats, helmets, bicycles, bracelets, belts, vests, jewelry, pendants, etc., so as to warn vehicles 100 and other users of the system 10 of them and vice versa so as to prevent collisions. As an example, this technology can be incorporated into a helmet or vest of road workers, or crossing guards. These persons are often at higher risk of a collision with a vehicle 100 as they are often in unexpected places, or are hidden by weather conditions, the angle of the sun, or other objects or conditions. With the radio transmitting device (200) located within an object these persons are wearing or carrying this device will alert oncoming vehicles 100 of the presence of the road worker or crossing guard as is described herein. This will help to prevent collisions with these persons, and with the persons these persons are with (such as crossing students). In addition, this technology can also be incorporated into any other transportation device such as boats, jet skis, snow mobiles, motorcycles, bikes, scooters, trains, trollies, etc.

In another embodiment, vehicle 100 has a steering wheel 150 with a steering wheel sensor 152 and an actuation switch or deactivation switch 154. Steering wheel sensor 152 acts to sense whether a user has 2, 1 or no hands on the steering wheel 150 and sends this information to one or more of the processors 104, 106, 116. Steering wheel sensor 152 includes a pressure sensor. The early warning system 10 will take into account whether a user is driving with 2, 1 or no hands on the steering wheel 150. It is generally true that a person driving with 2 hands on the wheel is safer, has more control over the vehicle, is paying more attention to driving, and is quicker to respond to hazard situations than a person with 1 or 0 hands on the wheel. Similarly, it is generally true that a person driving with 1 hand on the wheel is safer, has more control over the vehicle, is paying more attention to driving, and is quicker to respond to hazard situations than a person with 0 hands on the wheel. As such, the early warning system 10 will factor the number of hands on steering wheel 150 into the determination as to when to issue a warning signal. The sensor 152 will also sense the location of the user's hands, and whether they are using their leg or knee to steer, and will also take this information into account. That is, a warning signal is issued more quickly when the user is driving with 1 hand or a knee on the steering wheel 150 as opposed to 2 hands on the wheel. Similarly, a warning signal is issued more quickly when the user is driving with no hands on the steering wheel 150 as opposed to 1 hand on the wheel. In addition, a warning signal may be issued when the driver is driving without any hands on the steering wheel 150 when no hands have been on the steering wheel for a predetermined amount of time; or when only one hand has been on the steering wheel for a predetermined amount of time. In addition, a sensor is connected to the gas pedal is also incorporated into the system 10 wherein when the sensor on the gas pedal senses that no pressure has been applied to the gas pedal for a predetermined amount of time, coupled with a lack of hands on the steering wheel 150 for a predetermined amount of time, a warning signal is sent indicating a medically incapable driver situation. In addition, steering wheel 150 also has an indicator 156, such as a light, display, pulsing member or vibrating device, which sends a signal to the user when a warning signal occurs, such as vibrating, pulsing or illumination of a light or display, as is described above.

When a warning signal is issued by the early warning system 10, the user must acknowledge the issuance of the warning signal by engaging the deactivation switch 154. Deactivation switch 154 is a button positioned conveniently at the 10 and 2 positions on the steering wheel, either on the user side or on the side opposite the user. Alternatively, deactivation switch 154 is incorporated within the steering wheel 150 and is activated/deactivated by simply squeezing the steering wheel 150 which is sensed through the steering wheel pressure sensor 152. If the user fails to acknowledge the warning signal within a predetermined amount of time, the warning system 114 will escalate the warning signal, as is described above, until the warning signal is acknowledged. If the driver does not acknowledge the escalating warning signal for a predetermined about of time, early warning system 10 will disengage cruise control, take over control of the vehicle 100, slow the vehicle down, steer it to the side of the road, activate warning lights, summons emergency personnel, alarm surrounding vehicles, etc., as is described above. Guidance of the vehicle 100 is accomplished through sensor 10, GPS information, information from other vehicles 100 which are part of the system, signals 300 and another information available through the system 10.

In another embodiment, early warning system 10 has a verification system 160 for official vehicles 100A, such as emergency vehicles, police vehicles, sheriff, state patrol, emergency responder, ambulance, fire marshal, park ranger, DNR officer, border patrol, coast guard and other official vehicles (hereinafter “official vehicles”). In the event that a vehicle 100 which is part of this system 10 is pulled over or approached by an official vehicle 100A driven by official agent (hereinafter “official agent”), as the official vehicle 100A pulls within a proximate distance of the user's vehicle 100, the official vehicle 100 automatically sends a verification signal 162 to the driver's early warning system 10.

Alternatively, sensor 108 senses that the driver is being pulled over by an official agent, by sensing a squad car's flashing lights, siren, or other signal and thereafter requests verification signal 162. In this arrangement, it is preferable to locate sensor 108 in the back of vehicle 100.

Alternatively, instead of receiving this information automatically, in the event a driver is being pulled over, or is otherwise approached by an official agent, the user activates the verification system 160, through visual display 122 or input device 128, which requests for a verification signal 162.

Verification signal 162 is sent through the use and incorporation of GPS systems, satellite systems, cell phone technology, direct radio communication, or any other communication means. The verification signal is sent from the official vehicle 100A or from command center 400 or an independent third party verification system.

Verification signal 162 includes the agency's name, (e.g. Boston Police, Florida Highway Patrol, etc.); the agent's name; a physical description of the agent; the agent's badge number; the vehicle number; a picture of the agent; the reason why they are pulling the driver over, and any other relevant information. This information is displayed for the driver on their visual display 122, 222.

In the event that no verification signal 162 is received or verification is denied, a distress signal is sent command center 400, the closest police or highway patrol member and/or station requesting immediate assistance. In the event that when the official agent approaches the user and they are different than the verification signal 162 indicated the user can immediately summon emergency services through the system 10 by pressing an emergency button on visual display 122 or input device 128. When verification is denied the visual alarm 124 and audible alarm 126 on vehicle 100 is activated to warn the surrounding public and to attract attention. In addition a camera or video camera connected to the vehicle 100 is activated to record the traffic stop.

In addition, when an official vehicle 100A pulls over vehicle 100, not only is a verification signal 162 sent to the vehicle 100, but a verification signal 162 is sent back to the official vehicle 100A. This verification signal 162 includes the driver's name; a physical description of the driver; the driver's driving and criminal history; a picture of the driver; and the driver's license, registration and insurance information. Preferably, the official agent does not approach the vehicle 100 until after a verification signal 162 has been sent and received by both vehicles 100, 100A.

In this way, verification system 160 protects users from abduction, murder, robbery, rape, assault, etc. The verification system 160 also improves the accuracy and efficiency of traffic stops and improves the relationships between law enforcement and the general public by eliminating the possibility of an impersonator.

From the above discussion it will be appreciated that the above-described early warning system offers many features and advantages over the prior art. Accordingly, the early warning system provides a system and device that alert drivers to dangerous conditions. This system and device also improves the safety of driving and reduces the number of injuries and fatalities due to automobile accidents. This system and device also reduces the amount of property damage caused by automobile accidents.

It will be appreciated by those skilled in the art that other various modifications could be made to the device without parting from the spirit and scope of this invention. All such modifications and changes fall within the scope of the claims and are intended to be covered thereby.

1. An early warning system, comprising:
a vehicle having a warning device;
said vehicle having a steering wheel with a steering wheel sensor;
said steering wheel sensor capable of sensing whether a driver has two hands, one hand or no hands on the steering wheel;
wherein when the steering wheel sensor senses that no hands are on the steering wheel a hazard condition is detected and a warning signal is issued through the warning device.

2. The early warning system of claim 1, further comprising an actuation switch connected to the steering wheel, wherein when a warning signal is issued it is deactivated by engaging the actuation switch.

3. The early warning system of claim 1, wherein when a hazard condition is determined to occur only after a predetermined amount of time after the steering wheel sensor senses that no hands are on the steering wheel.

4. A verification system for verifying the identity of official agents, comprising:
a first vehicle having an early warning device;
said early warning device having a visual display;
wherein when the first vehicle is approached by an official vehicle a verification signal is sent to the first vehicle;
wherein when the first vehicle receives the verification signal, verification information is displayed the visual display.

5. The verification system of claim 4 wherein the verification information includes the name of the official agent in the official vehicle.

6. The verification system of claim 4 wherein the verification information includes a picture of the official agent in the official vehicle.

7. The verification system of claim 4 further comprising wherein when the first vehicle is approached by the official vehicle the warning device requests a verification signal.

8. The verification system of claim 4 wherein when verification information does not match the official agent a distress signal is sent.

9. The verification system of claim 4 further comprising a sensor connected to the first signal which senses when the first vehicle is approached by an official vehicle.

10. The verification system of claim 4 wherein when the first vehicle is approached by an official vehicle, a driver of the first vehicle activates the verification system which requests a verification signal.

11. An early warning system, comprising:
a first vehicle;
said first vehicle having a receiver, a processor, a sensor, a warning device, and software;
wherein said first vehicle's sensor senses the speed and direction of the first vehicle;
wherein said first vehicle's receiver receives information regarding the position of hazards;
wherein said first vehicle's processor calculates whether a warning condition exists pursuant to the software;
wherein when a warning condition is sensed an alarm is activated.

12. The early warning system of claim 11 wherein the alarm is a visual alarm.

13. The early warning system of claim 11 wherein the alarm is an audible alarm.

14. The early warning system of claim 11 wherein as the severity of the warning condition escalates the severity of the warning signal escalates.

15. The early warning system of claim 11 wherein when the processor determines a collision will occur with a hazard a controller controls the vehicle to avoid the hazard.

16. The early warning system of claim 15 wherein the hazard is a second vehicle having a transmitter.

17. The early warning system of claim 15 wherein the hazard is a pedestrian with an electronic device having a transmitter.
